(19) United States
(12) Patent Application Publication
(10) Pub. No.: US 2011/0176476 A1
(43) Pub. Date: Jul. 21, 2011

(54) RELAY DEVICE, TERMINAL DEVICE, AND COMMUNICATION SYSTEM

(75) Inventor: Tetsumei TSURUOKA, Kawasaki (JP)

(73) Assignee: FUJITSU LIMITED, Kawasaki-shi (JP)

(21) Appl. No.: 13/079,278

(22) Filed: Apr. 4, 2011

Related U.S. Application Data
(63) Continuation of application No. PCT/JP2008/068241, filed on Oct. 7, 2008.

(51) Int. Cl. H04W 76/02

(52) U.S. Cl. 370/315

(57) ABSTRACT

A terminal device directly communicates with a base station by using a WiMAX™ connection. If the user moves the terminal device and switches from the direct wireless connection established with the base station to a relayed connection established with the base station via a relay device, the terminal device sends a connection request to the relay device. When a connection request is received from the terminal device, the relay device switches the connection between the terminal device and the base station to a WiMAX connection, established via the relay device. Once the relayed connection is established between the terminal device and the base station, the relay device relays data between the terminal device and the base station, using a Wi-Fi connection between the relay device and the terminal device, and using the WiMAX connection between the relay device and the base station.

### CROSS-REFERENCE TO RELATED APPLICATIONS

This application is a continuation of International Application No. PCT/JP2008/068241, filed on Oct. 7, 2008, the entire contents of which are incorporated herein by reference.

### FIELD

The embodiments discussed herein are directed to a relay device, a terminal device, and a communication system.

### BACKGROUND

In recent years, a mobile access system has been put to practice in which base stations are built outdoors so as to provide a wide coverage area via the base stations. For example, as illustrated in FIG. 12, a mobile access system is used for various high-speed data communication applications that are related not only to handheld devices such as cellular phones but also to personal computers (PCs) equipped with PC cards having the wireless interface (I/F) function or to in-vehicle terminal devices. Herein, FIG. 12 is an illustrative diagram for explaining a conventional mobile access system.

Moreover, for example, in the mobile WiMAX technology (WiMAX is a registered trademark and stands for Worldwide Interoperability for Microwave Access) that meets the IEEE802.16e standard; OFDMA (which stands for Orthogonal Frequency Division Multiplexing Access) is implemented as the wireless communication protocol, and a communication speed of several tens of Mbps (megabit per second) by implementing the MIMO technology (MIMO stands for Multiple Input Multiple Output) in addition to using a plurality of sub-carriers performing modulation at a high coding rate such as 64-QAM (which stands for Quadrature Amplitude Modulation).

However, regarding such a wireless system, since the base stations are generally built outdoors, the radio wave environment undergoes deterioration if the wireless system is used indoors rather than outdoors. Moreover, in the wireless communication technology such as the WiMAX technology, since the communication method is altered according to the radio wave environment, the deterioration in the radio wave environment also causes a decline in the communication speed.

Meanwhile, as far as indoor use is concerned, many of the households use either wired or wireless LAN (which stands for Local Area Network) having the ADSL connection (ADSL stands for Asymmetric Digital Subscriber Line) or the optical broadband connection. Besides, the terminal devices are equipped, as standard, with interfaces of the wired LAN (such as Ethernet (registered trademark)) or the wireless LAN (such as Wi-Fi (which is a registered trademark and stands for Wireless Fidelity)). That makes it possible to perform various types of indoor communication as described above.

Thus, a terminal device capable of performing various types of communication performs communication by making use of different types of connection schemes such as wireless connection services used at outdoor locations and indoor communication tools used at indoor locations. Thus, while switching between different types of connection schemes, the sessions (connection) being used for communication get lost. With regard to that issue, as a technology that makes it possible to continue communication while preventing the connection used for communication from being lost, the mobile IP technology (IP stands for Internet Protocol) is implemented.

The mobile IP technology is capable of switching between different connection schemes while using apparently the same IP addresses. For example, as illustrated in FIG. 13, at an outdoor location, the mobile IP technology establishes a connection with a wireless connection service (such as a WiMAX service, and, at an indoor location, the mobile IP technology switches to a connection established by using Ethernet while also retaining the connection established for outdoor use. Herein, FIG. 13 is an illustrative diagram for explaining the conventional mobile IP technology.

Moreover, in the WiMAX technology that meets the IEEE802.16j standard, a technique is known that makes use of a repeater RS (relay station) that relays the radio waves transmitted by a base station BS (base station). For example, as illustrated in FIG. 14, in the technology using the RS, it is still the WiMAX connection that is used as the connection scheme. At the terminal device side, the communication is handed over from the BS located outdoors to the RS located indoors. Then, the RS establishes a connection with the BS located outdoors and relays the data to be communicated between the terminal device and the BS. Herein, FIG. 14 is an illustrative diagram for explaining a conventional technology of using a repeater.

Meanwhile, regarding indoor locations such as public facilities or shops, there are times when indoor base stations (i.e., compact base stations called “femto base stations (fBS)”) are installed on an individual basis. For example, as illustrated in FIG. 15, it is still the WiMAX connection that is used as the connection scheme. At the terminal device side, the communication is handed over from the BS located outdoors to the fBS located indoors. Then, without relaying via the BS located outdoors, the fBS establishes a direct connection with a gateway (GW) of a wireless access network. Herein, FIG. 15 is an illustrative diagram for explaining a conventional technology of using a compact base station.

Meanwhile, a communication system has been disclosed in which, for example, the resources inside a communication carrier network to which a particular mobile terminal device belongs are accessed by a device other than the mobile terminal device from a local network via the mobile terminal device.
Patent Document: Japanese Laid-open Patent Publication No. 2006-121728

However, in the abovementioned conventional technologies, switching between different types of connection schemes in a seamless manner is not an easy task.

More particularly, in the conventional technology illustrated in FIG. 13, it is a time-consuming task to switch between two different types of network services, namely, a wireless access network and a wired access network. As a result, in the conventional technology illustrated in FIG. 13, switching between the connection schemes cannot be achieved in a swift (seamless) manner. Moreover, in the conventional technology illustrated in FIG. 13, when each network provides unique services, it becomes difficult to make continual use of such services. that leads to degradation of the services.

In the conventional technology illustrated in FIG. 14, while switching the connection scheme from a WiMAX connection to a WiMAX connection; since the same frequency band is used, radio wave interference occurs between the upstream and the downstream. Moreover, in the conventional technology illustrated in FIG. 14, buffering is once performed while establishing a relayed connection via the RS. Hence, while making use of the TDD format (TDD stands for Time Division Duplex), the protocol for absorbing the delay in relaying is expanded in order to prevent the relay timing from shifting.

In the conventional technology illustrated in FIG. 15, it is expensive to lay the line connecting an indoor location to the BS. Moreover, since the BS is generally kept under the administration of the mobile connection network provider, administration and operation of the BS are complex tasks to handle.

### SUMMARY

According to an aspect of an embodiment of the invention, a relay device includes a mobile communication interface unit configured to communicate with base stations; an internal communication interface unit configured to communicate with terminal devices; and a processor. The processor is configured to establish a wireless connection with a base station by using a second communication method in response to a connection request, the connection request being received by using a first communication method from a terminal device having wireless communication capability and being issued with respect to the base station; and to relay, upon establishment of a wireless connection with the base station, data to be communicated between the terminal device and the base station by using the first communication method and the second communication method.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an illustrative diagram of an exemplary system configuration according to a first embodiment of the present invention;

FIG. 2 is a schematic diagram of a configuration example of a relay device according to the first embodiment;

FIG. 3 is a schematic diagram of a configuration example of a terminal device according to the first embodiment;

FIG. 4 is an illustrative diagram for explaining an authentication message processing according to the first embodiment;

FIG. 5 is an illustrative diagram for explaining a disconnection request processing according to the first embodiment;

FIG. 6 is an illustrative diagram for explaining a relay termination processing according to the first embodiment;

FIG. 7 is an illustrative diagram for explaining a relay processing performed from the start of communication according to the first embodiment;

FIG. 8 is an illustrative diagram of an exemplary frame configuration of a frame subjected to communication;

FIG. 9 is an illustrative diagram of an exemplary connection configuration in the communication system;

FIG. 10 is an exemplary block diagram of a computer that executes a relay program;

FIG. 11 is a block diagram of a computer that executes a relayed connection switchover program;

FIG. 12 is an illustrative diagram for explaining a conventional mobile access system;

FIG. 13 is an illustrative diagram for explaining the conventional mobile IP technology;

FIG. 14 is an illustrative diagram for explaining a conventional technology of using a repeater; and

FIG. 15 is an illustrative diagram for explaining a conventional technology of using a compact base station.

### DESCRIPTION OF EMBODIMENTS

Preferred embodiments of the present invention will be explained with reference to accompanying drawings.

### [a] First Embodiment

### System Configuration

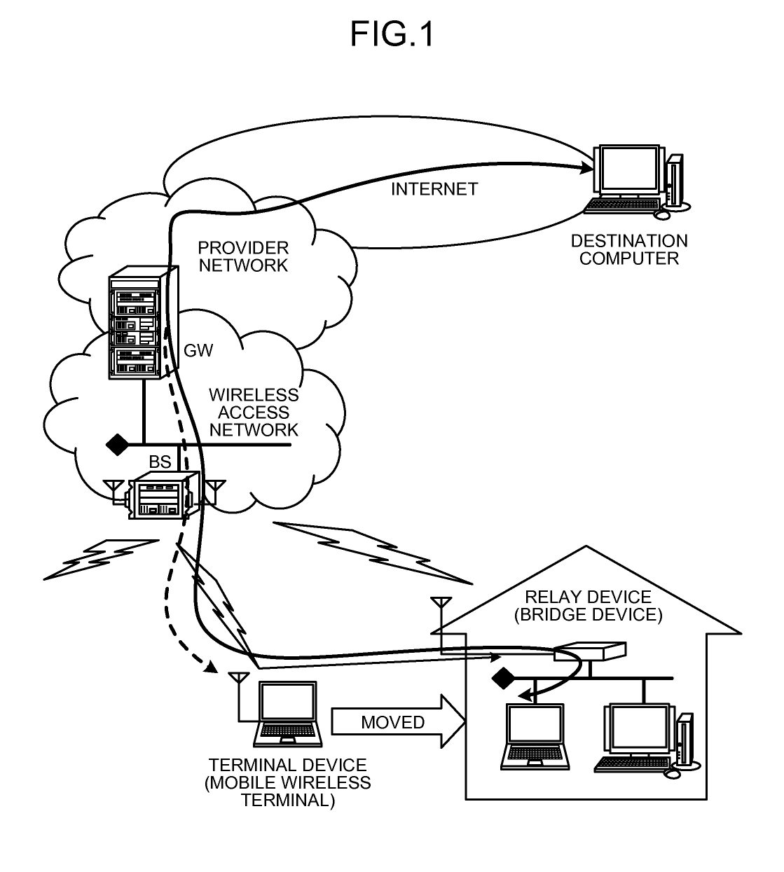

Firstly, explained below with reference to FIG. 1 is a system configuration according to a first embodiment of the present invention. FIG. 1 is an illustrative diagram of an exemplary system configuration according to the first embodiment. As illustrated in FIG. 1, in the system disclosed herein, via a base station (BS) and a gateway device (GW), a terminal device with a WiMAX (WiMAX is a registered trademark) interface and a destination computer are connected to one another either directly when the terminal device is located outdoors or via a relay device (bridge device) when the terminal device is located indoors. Herein, the destination computer represents various services provided via the Internet.

Thus, in such a configuration, the system according to the first embodiment is a communication system including a terminal device and a relay device. The terminal device establishes a wireless connection with the relay device by using a first communication method. Moreover, the terminal device establishes a wireless connection with a base station by using a second communication method. At the time of switching from the direct wireless connection established between the terminal device and the base station to a wireless connection established via the relay device between the terminal device and the base station, the terminal device sends a connection request to the relay device.

More particularly, when located outdoors, the terminal device directly communicates with the base station by using the WiMAX connection. If the user moves the terminal device to an indoor location; then, with the aim of switching from the direct communication with the base station to a relayed communication established with the base station via the relay device, the terminal device sends a connection request to the relay device. The connection between the relay device and the terminal device located indoors is established by using, for example, the Ethernet (registered trademark)/Wi-Fi (registered trademark) connection, and the switchover to the relayed communication is done when the terminal device receives a notice in the form of a broadcast that is periodically transmitted by the relay device.

Once a connection request with respect to a base station is received from the terminal device by using the first communication method, the relay device establishes a wireless connection with the base station by using the second communication method. Once the wireless connection is established with the base station, the relay device makes use of the first communication method as well as the second communication method for relaying the data to be communicated between the terminal device and the base station.

More particularly, in the abovementioned example, once a connection request with respect to a base station is received from the terminal device by using the Ethernet/Wi-Fi connection, the relay device switches the connection scheme between the terminal device and the base station to the WiMAX connection established via the relay device.

Once a relayed communication is established between the terminal device and the base station, the relay device relays the data to be communicated between the terminal device and the base station by using the Ethernet/Wi-Fi connection between the relay device and the terminal device and by using the WiMAX connection between the relay device and the base station.

Thus, even when located indoors, the relay device and the terminal device are operated as if only a single terminal device is working. Hence, irrespective of whether the terminal device is located outdoors or indoors, the base station is able to continue the communication without any change in the connection status. In other words, irrespective of whether the terminal device is located outdoors or indoors, the base station is able to continue the communication by using The WiMAX connection.

In the communication system described above, regarding the connection between the terminal device and the base station, when the terminal device is moved from an outdoor location having favorable communication environment to an indoor location having unfavorable communication environment, the connection scheme is switched to a relayed communication established via the relay device without changing the communication method. As a result, it becomes possible switch the connection scheme in a swift (seamless) manner.

Configuration of Relay Device

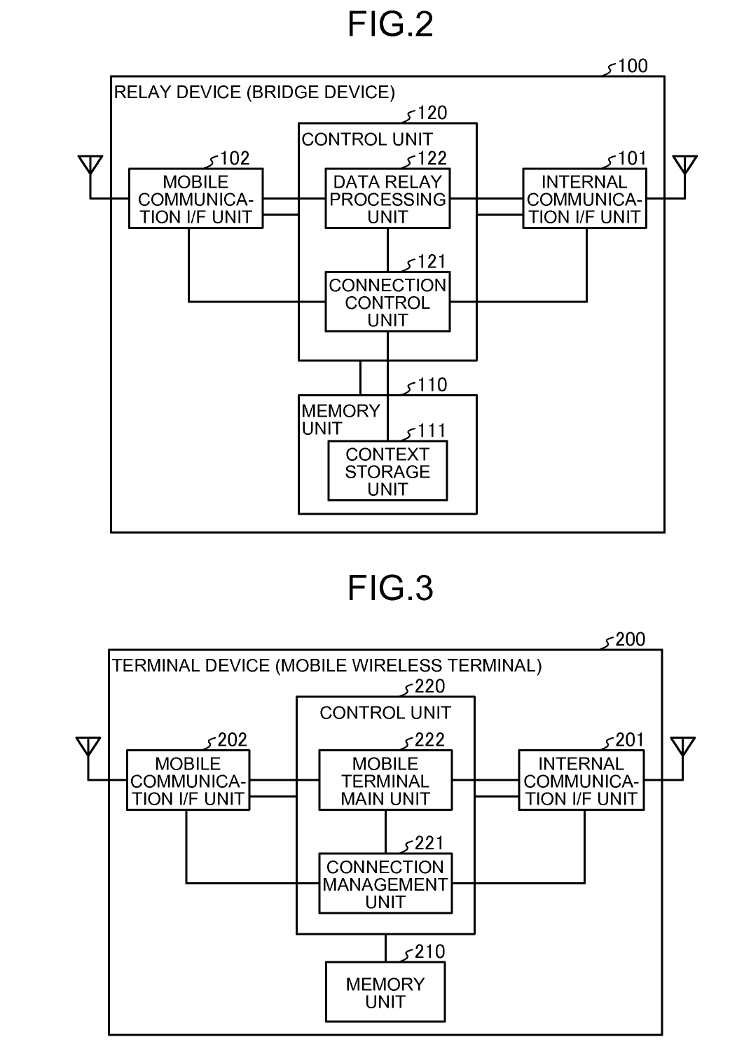

Explained below with reference to FIG. 2 is a configuration example of the relay device according to the first embodiment. FIG. 2 is a schematic diagram of a configuration example of the relay device according to the first embodiment. As illustrated in FIG. 2, a relay device 100 includes an internal communication I/F unit 101, a mobile communication I/F unit 102, a memory unit 110, and a control unit 120.

The internal communication I/F unit 101 establishes a connection with a terminal device having wireless communication capability and performs communication with the terminal device by using the first communication method. For example, the internal communication I/F unit 101 establishes a connection with a terminal device having wireless communication capability and performs communication by using the Ethernet/Wi-Fi connection. Moreover, for example, at an indoor location having unfavorable communication environment as compared to outdoors, the internal communication I/F unit 101 receives from a terminal device a connection request with respect to a base station.

The mobile communication I/F unit 102 establishes a connection with a base station and communicates with that base station by using the second communication method. For example, when the internal communication I/F unit 101 receives from a terminal device a connection request with respect to a base station, the mobile communication I/F unit 102 communicates with the base station by establishing a WiMAX connection. Meanwhile, although a WiMAX connection established between the terminal device and the base station can also be used from indoors, the communication environment would be inferior as compared to outdoors.

The memory unit 110 is used to store the necessary data for various operations performed by the control unit 120 and various operation results obtained by the control unit 120. Particularly, the memory unit 110 includes a context storage unit 111. Herein, for example, the memory unit 110 stores therein a variety of information used for the purpose of establishing a relayed connection between the terminal device and the base station (i.e., stores information related to the connection).

The context storage unit 111 stores therein context information that may contain one or more of an identifier of the terminal device, the central frequency of the base station, an identifier of the base station, a connection identifier of the connection with the base station, an authentication key, and a cryptography key. For example, the context storage unit 111 stores therein context information that contains either one of (or all of) the following items: the MAC address as the identifier of the terminal device, the central frequency of the base station, the identifier of the base station (referred to as BSID), the connection identifier (referred to as CID) of the connection with the base station, the authentication key used during the authentication sequence, and the cryptography key that is related to the connection and communicated in an encrypted form.

The control unit 120 includes an internal memory for storing a control program, a program defining various operations sequences, and necessary data. Particularly, the control unit 120 includes a connection control unit 121 and a data relay processing unit 122, and uses these constituent elements for performing various operations.

When a connection request with respect to a base station is received by using the first communication method from a terminal device having wireless communication capability, the connection control unit 121 establishes a wireless communication with the base station by using the second communication method. For example, when a connection request with respect to the base station is received from the terminal device by using the Ethernet/Wi-Fi connection, the connection control unit 121 switches the connection scheme between the terminal device and the base station to the WiMAX connection established via the relay device 100.

Meanwhile, for example, after the relay device 100 demonstrates its existence by periodically transmitting a broadcast to the terminal device or by responding to a broadcast transmitted by the terminal device, the terminal device sends a connection request to the relay device 100.

Moreover, the connection request includes the abovementioned context information. Thus, at the time of establishing a connection with a base station by using the second communication method, the connection control unit 121 stores the context information in the context storage unit 111.

For example, from a connection request sent by the terminal device, the connection control unit 121 receives the context information such as the identifier of the base station (referred to as BSID) or the connection identifier (referred to as CID) or the like, and attempts to establish a connection with the base station while storing the context information in the context storage unit 111. Meanwhile, in addition to the abovementioned information, the context information can also represent the information related to the state of the terminal device in the MAC layer.

Once the connection control unit 121 establishes a wireless connection with the base station, the data relay processing unit 122 relays the data to be communicated between the terminal device and the base station by using the first communication method as well as the second communication method.

For example, once the connection control unit 121 establishes the relayed communication between the terminal device and the base station, the data relay processing unit 122 relays the data to be communicated between the terminal device and the base station by using the Ethernet/Wi-Fi connection between the relay device 100 and the terminal device, and by using the WiMAX connection between the relay device 100 and the base station.

Configuration of Terminal Device

Explained below with reference to FIG. 3 is a configuration example of the terminal device according to the first embodiment. FIG. 3 is a schematic diagram of a configuration example of the terminal device according to the first embodiment. As illustrated in FIG. 3, a terminal device 200 includes an internal communication I/F unit 201, a mobile communication I/F unit 202, a memory unit 210, and a control unit 220.

The internal communication I/F unit 201 establishes a connection with a relay device having wireless communication capability and performs communication with the relay device by using the first communication method. For example, the internal communication I/F unit 201 establishes a connection with the relay device 100 having wireless communication capability and performs communication by using the Ethernet/Wi-Fi connection. Besides, for example, at an indoor location having unfavorable communication environment as compared to outdoors, the internal communication I/F unit 201 sends to the relay device 100 a connection request with respect to a base station.

The mobile communication I/F unit 202 establishes a wireless connection with a base station by using the second communication method. For example, at an outdoor location having favorable communication environment as compared to indoors, the mobile communication I/F unit 202 communicates with the base station by establishing a WiMAX connection. Meanwhile, although a WiMAX connection established by the terminal device 200 with the base station can also be used from indoors, the communication environment happens to be inferior as compared to outdoors.

The memory unit 210 is used to store the necessary data for various operations performed by the control unit 220 and various operation results obtained by the control unit 220.

The control unit 220 includes an internal memory for storing a control program, a program defining various operations sequences, and necessary data. Particularly, the control unit 220 includes a connection management unit 221 and a mobile terminal main unit 222, and uses these constituent elements for performing various operations.

At the time of switching the connection scheme from the direct wireless connection established with the base station to a wireless connection established with the base station via the relay device 100, the connection control unit 121 sends a connection request to the relay device 100. For example, at the time of switching the connection scheme from the direct wireless connection established (by the mobile communication I/F unit 202) with the base station by using a WiMAX connection to the relayed communication for communicating with the base station via the relay device 100, the connection control unit 121 sends a connection request to the relay device 100.

Meanwhile, at an indoor location, the relay device 100 and the terminal device 200 are connected by the Ethernet/Wi-Fi connection. At the time of switching to the relayed communication, for example, the switchover to the relayed communication is done when the terminal device 200 receives a notice in the form of a broadcast that is periodically transmitted by the relay device 100.

The mobile terminal main unit 222 performs different operations than the control operations performed by the connection management unit 221 regarding the relayed communication between the terminal device 200 and the base station. For example, the mobile terminal main unit 222 performs control operations regarding the basic connection of the terminal device 200, that is, regarding the direct connection established with the base station without using the relay device 100.

Determination of Transmission Power

Herein, when the relayed communication via the relay device 100 is performed between the terminal device 200 and the base station, the relay device 100 controls the transmission power between the terminal device 200 and the base station. Regarding the parameters used while controlling the transmission power; since the radio wave environment between the terminal device 200 and the base station is not always the same, the parameters that have been set at the time of connecting the terminal device 200 to the base station cannot be inherited without change. Keeping that in mind, given below is the explanation of the transmission power between the terminal device 200 and the base station.

More particularly, before being sent by the terminal device 200, the connection request is assumed to include transmission power control information regarding the transmission power between the terminal device 200 and a base station with which the terminal device 200 has established a wireless connection. Then, at the time of establishing a wireless connection with the base station by using the second communication method, the relay device 100 determines the transmission power based on the transmission power control information and based on the electrical power received from the base station.

More particularly, firstly, the relay device 100 obtains the parameters used while controlling the transmission power in the terminal device 200 and obtains information regarding the reception radio field intensity of the terminal device 200. Then, depending on the difference between the obtained information and the radio field intensity received from the base station, the relay device 100 calculates the transmission power and determines an appropriate value thereof.

For example, in the WiMAX technology, for each closed loop sub-carrier, the electrical power is controlled by using the following expression:

P_{new}=Pₗₐₛₜ+(C/N_{new}C/Nₗₐₛₜ)−(10 log₁₀(R_{new})−10 log₁₀(Rₗₐₛₜ))+Offset

The abovementioned expression is transformed into the following expression:

P_{new}=P_{last-ref}+C/N_{new}−10 log₁₀(R_{new})+Offset

Then, the amount of fluctuation in the burst is controlled with reference to, for example, “0” as the sub-carrier power of a virtual burst.

Subsequently, from the terminal device 200, the relay device 100 receives the P_{last-ref} of the terminal device 200 and receives the RSSI (which stands for Received Signal Strength Indication) with respect to the base station with which the terminal device 200 has been connected. Then, as the amount of electrical power that can balance out the difference between the abovementioned RSSI and the RSSI at the time when the relay device 100 receives radio waves from the base station, the relay device 100 sets the P_{last-ref} thereof by adjusting the P_{last-ref} of the terminal device 200.

On the other hand, regarding the electrical power control in the open loop, the relay device 100 receives from the terminal device 200 the parameters used while controlling the transmission power, and calculates the sub-carrier power on the basis of the RSSI received from the base station. Moreover, even for the open loop, in the retain mode in which the transmission power is inherited so as to eliminate difference in the electrical power levels, the relay device 100 can be configured to receive the RSSI from the base station that is performing the relayed communication with the terminal device 200 and then adjust the offset amount in such a way that the resultant electrical power balances out the difference between the RSSI of the base station and the RSSI of the relay device 100.

Given below are the definitions used in the abovementioned definitions.

P_{new}: the power of the new UL burst in the current UL frame
C/N_{new}: normalized C/N for the new UL burst in the current UL frame
R_{new}: repetition factor R for the new UL burst in the current UL frame
Pₗₐₛₜ: the power of the burst with the maximum value of (C/N
10 log₁₀(R)) in the most recently transmitted UL frame
C/Nₗₐₛₜ: normalized C/N associated with Pₗₐₛₜ (thus, referring to the burst with the maximum value of (C/N 10 log₁₀(R)) in the most recently transmitted UL frame)
Rₗₐₛₜ: repetition factor R associated with Pₗₐₛₜ (thus, referring to the burst with the maximum value of (C/N 10 log₁₀(R)) in the most recently transmitted UL frame)
Offset: an accumulation of power correction terms sent by the BS since the last transmission

Meanwhile, the transmission power control information with respect to the connection with the base station is stored in the memory unit. At the time of establishing a wireless connection with the base station by using the second communication method, the relay device 100 sets the corresponding transmission power control information stored in the memory unit as the initial value of the transmission power.

For example, in the memory unit 210, the relay device 100 stores the past transmission power (or the reference offset amount) for each base station connected or connected before. Each transmission power stored in the memory unit 210 can be the transmission power at the time of terminating the connection with a base station or can be the average transmission power of the connected period. Then, the relay device 100 receives from the terminal device 200 a connection request with respect to a base station and, if the transmission power control information of that base station is stored in the memory unit 210, sets the transmission power with respect to that base station as the initial value.

Although the transmission power stored in the memory unit 210 is set as the initial value, the transmission power can have some error since the information corresponds to a transmission power set in the past (however, on the other hand, because the transmission power is set in the past, the reliability is high and the error is within an acceptable range). Hence, more specifically, the transmission power is controlled by calculating the reference electrical power based on the transmission power control information stored in the memory unit 210.

Authentication Message Processing

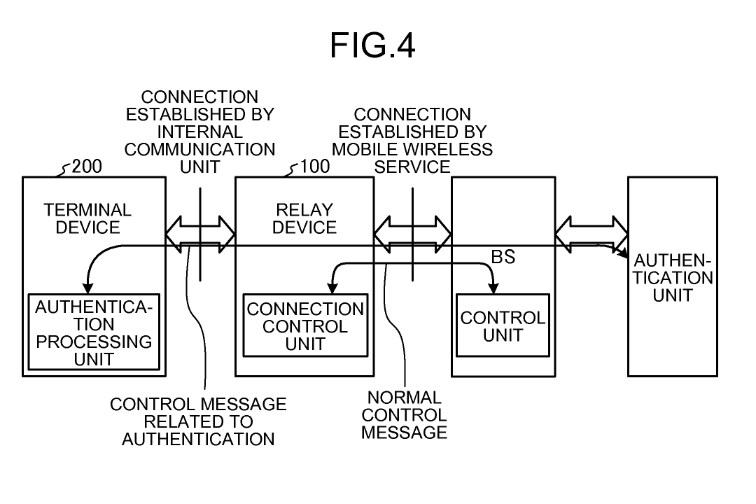

Explained below with reference to FIG. 4 is an authentication message processing according to the first embodiment. FIG. 4 is an illustrative diagram for explaining the authentication message processing according to the first embodiment.

More particularly, at the time of establishing a wireless connection with a base station by using the second communication method; the relay device 100 relays to the terminal device 200 a control message regarding wireless connection authentication received from the base station, relays to the base station a control message regarding wireless connection authentication received from the terminal device 200, and directly controls the messages other than the control messages.

Meanwhile, when the connection scheme is switched to a wireless connection between the terminal device 200 and a base station via the relay device 100, the terminal device 200 receives a control message regarding authentication from the relay device 100. Besides, when the connection scheme is switched to a wireless connection between the terminal device 200 and a base station via the relay device 100, the terminal device 200 sends a control message regarding authentication to the relay device 100.

For example, as illustrated in FIG. 4, even after the relayed communication is established between the terminal device 200 and a base station, the relay device 100 entrusts the terminal device 200 with the authentication processing regarding the terminal device 200, and transfers a control message related to authentication in an identical manner of relaying user packets between the terminal device 200 and the base station.

However, the messages other than the control message related to authentication are directly controlled by the relay device 100. Meanwhile, upon receiving a control message related to authentication, the terminal device 200 performs operations related to authentication and sends the control message related to authentication to the base station via the relay device 100.

Thus, even after the relayed communication via the relay device 100 starts functioning, the relay device 100 entrusts the terminal device 200 with the operations related to authentication that have been performed by the terminal device 200 during the period of direct connection with the base station. For that reason, without processing a control message, the relay device 100 transfers that control message to the terminal device 200.

Disconnection Request Processing

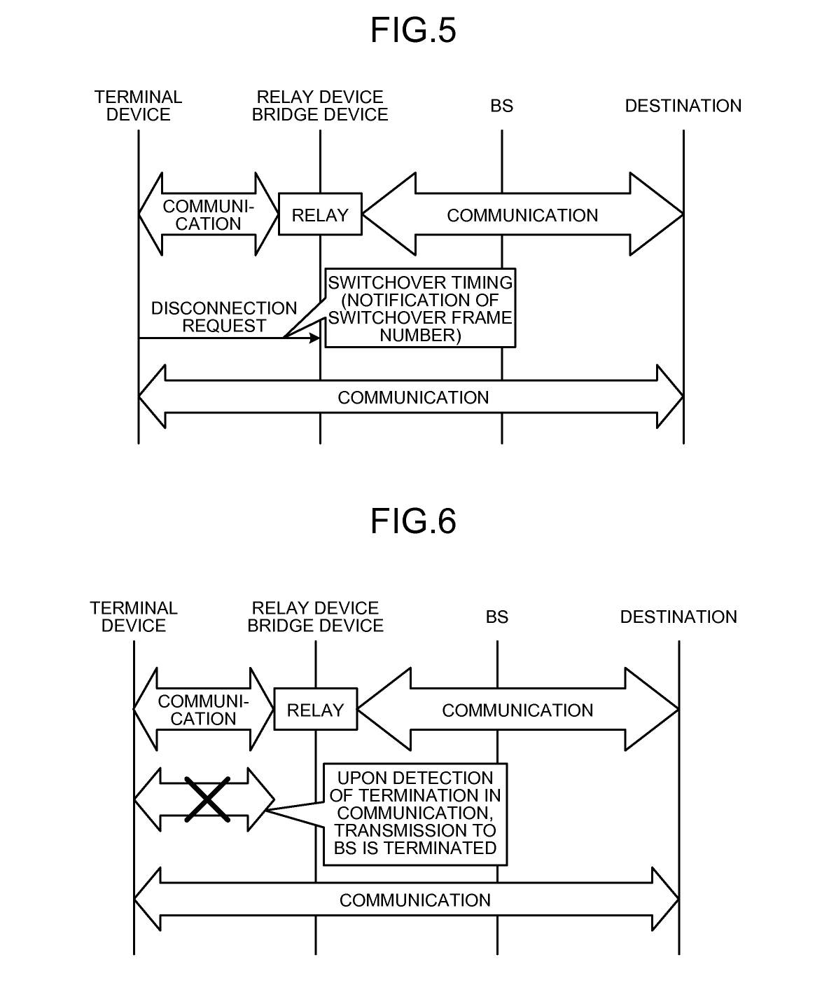

Explained below with reference to FIG. 5 is a disconnection request processing according to the first embodiment. FIG. 5 is an illustrative diagram for explaining the disconnection request processing according to the first embodiment.

More particularly, after the connection scheme is switched to a wireless connection established via the relay device 100 between the terminal device 200 and a base station, the terminal device 200 monitors the signals received from the base station. If the receiving sensitivity of those signals is satisfactory, then the terminal device 200 sends to the relay device 100 a connection switchback request for a connection with the base station. Upon receiving from the terminal device 200 a connection switchback request for a wireless connection with the base station, the relay device 100 terminates the wireless connection that has been established with the base station by using the second communicating method.

For example, as illustrated in FIG. 5, even after the connection scheme is switched to a relayed connection established via the relay device 100 between the terminal device 200 located indoors and a base station, the terminal device 200 continues to receive signals from the base station. If the user later moves the terminal device 200 to an outdoor location and if that results in an improvement in the strength of radio wave signals with respect to the base station, then the terminal device 200 sends to the relay device 100 a connection switchback request with the aim of terminating the relayed connection established via the relay device 100.

Upon receiving the connection switchback request from the terminal device 200, the relay device 100 terminates the relayed connection between the terminal device 200 and the base station after a switchover timing specified in the connection switchback request or after a switchover timing adjusted with the terminal device 200 according to the connection switchback request.

Meanwhile, in the WiMAX protocol, the frames are divided by using the TDD (Time Division Duplex) at periods of five milliseconds and are repeatedly subjected to downlinking (DL) and uplinking (UL), and the data is communicated according to the frame numbers of the frames. Hence, the above-mentioned switchover timing is determined to be the communication timing set in a predetermined frame number.

Thus, once the communication environment improves for a direct connection between the terminal device 200 and the base station, the relay device 100 receives a connection switchback request from the terminal device 200 and then terminates the relayed connection between the terminal device 200 and the base station after a switchover timing specified in the connection switchback request. As a result, the terminal device 200 becomes able to reestablish a direct connection with the base station.

Relay Termination Processing

Explained below with reference to FIG. 6 is a relay termination processing according to the first embodiment. FIG. 6 is an illustrative diagram for explaining the relay termination processing according to the first embodiment.

More particularly, once the communication with the terminal device 200 is terminated, the relay device 100 terminates the wireless connection that has been established with the base station by using the second communicating method. Besides, after the connection scheme is switched to a wireless connection established via the relay device 100 between the terminal device 200 and a base station; if the communication between the terminal device 200 and the relay device 100 is terminated, then the terminal device 200 switches the connection scheme to a direct wireless connection with the base station.

For example, as illustrated in FIG. 6, the relay device 100 makes use of the existence confirmation (keep alive) performed periodically with the terminal device 200 or the detection of a timeout occurring in the data communication as a trigger for terminating the relayed connection established between the terminal device 200 and the base station.

Moreover, for example, the terminal device 200 makes use of the existence confirmation (keep alive) performed periodically with the relay device 100 or the detection of a timeout occurring in the data communication as a trigger for switching the connection scheme from the relayed connection via the relay device 100 to a direct connection with the base station.

Besides, even after the connection scheme is switched from the direct connection with the base station to a relayed connection via the relay device 100, the terminal device 200 can be configured to continue to receive signals from the base station and, if the communication via the relay device 100 is terminated, to switch back to the direct connection with the base station that has been never discontinued.

Furthermore, while the relayed connection is established via the relay device 100; if the communication between with the terminal device 200 and the relay device 100 gets terminated, then the terminal device 200 can also be configured to attempt to reestablish the connection via the relay device 100 instead of switching to a direct connection with the base station. Thus, in short, the terminal device 200 establishes a relayed connection or a direct connection depending on the reason of termination in the communication.

That is to say, since the relay device 100 and/or the terminal device 200 make use of the existence confirmation performed mutually and periodically or make use of the detection of a timeout occurring in the data communication as a trigger for terminating the relayed connection, it becomes possible to switch between the connection schemes quickly while reducing the time for which the communication remains disabled.

Relay Processing from Start of Connection

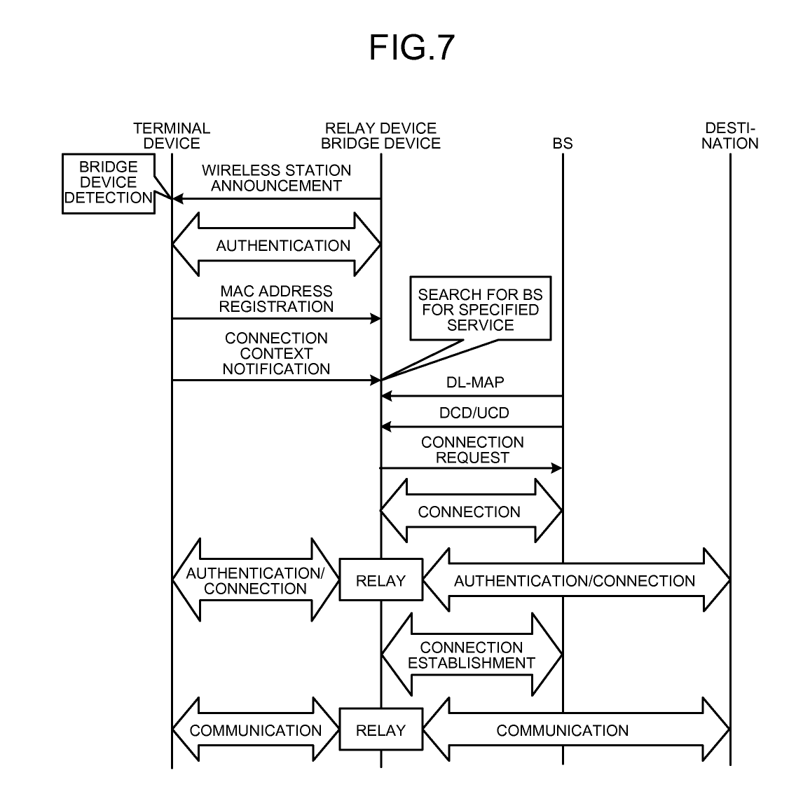

Given below with reference to FIG. 7 is the explanation regarding relay processing performed from the start of communication according to the first embodiment. FIG. 7 is an illustrative diagram for explaining the relay processing performed from the start of communication according to the first embodiment.

More particularly, the terminal device 200 does not establish a direct connection with a base station but sends to the relay device 100 a connection request with the aim of establishing an initial connection with the base station. Once the connection request for establishing an initial connection with the base station is received from the terminal device 200 by using the first communication method, the relay device 100 establishes a wireless communication with the base station by using the second communication method.

For example, as illustrated in FIG. 7, the terminal device 200 receives, from the relay device 100, a wireless station announcement during the periodical broadcast and, upon detecting the relay device 100, sends the MAC address of the WiMAX connection and the context information related to the connection with the relay device 100.

Based on the received context information, the relay device 100 establishes a connection with the base station by using the WiMAX communication method. Subsequently, the terminal device 200 sends the information related to authentication to the base station (destination) via the relay device 100. Then, by using the relayed connection established via the relay device 100, the terminal device 200 performs data communication with the base station.

During the period of the initial connection, the relayed connection established via the relay device 100 is put to use when the terminal device 200 scans in advance the base station as the destination and determines that the relayed connection via the relay device 100 is the more stable connection scheme. On the other hand, during the period of the relayed connection established via the relay device 100, the terminal device 200 keeps a direct connection with the base station established in preparation for the case of losing the connection with the relay device 100.

Thus, in the case when no connection is established between a base station and the terminal device 200 and when a relayed connection established via the relay device 100 is the more stable connection scheme; during the period of the initial connection, the terminal device 200 establishes a relayed connection via the relay device 100 as well as establishes a direct connection with the base station. As a result, it becomes possible to keep on using the more stable service.

Frame Configuration and Connection Configuration

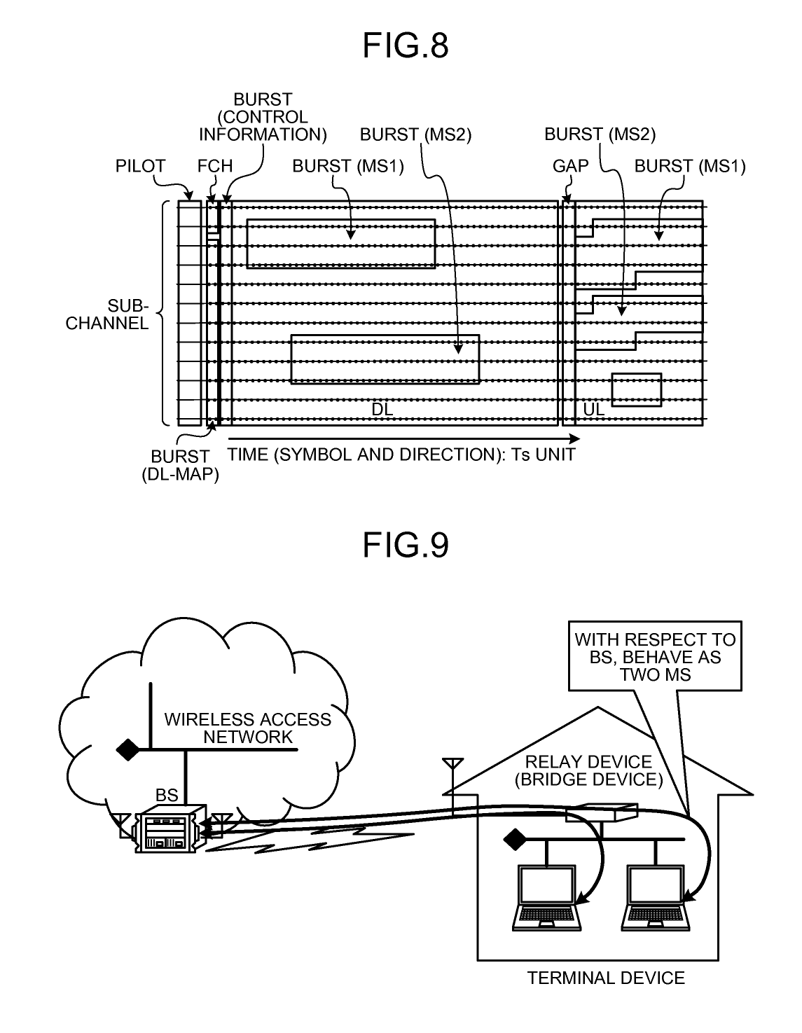

Given below with reference to FIGS. 8 and 9 is the explanation of a frame configuration of a frame subjected to communication and the explanation of a connection configuration in the communication system. FIG. 8 is an illustrative diagram of an exemplary frame configuration of a frame subjected to communication, while FIG. 9 is an illustrative diagram of an exemplary connection configuration in the communication system.

For example, as illustrated in FIG. 8, in the WiMAX technology, an access method is implemented in which selective use of sub-channels and division along the time axis direction enables reception of data addressed to a different terminal device and data from a different terminal device.

Thus, as illustrated in FIG. 9, consider the case when a single base station is shared for a plurality of terminal devices. In that case, if the context information of each of the terminal devices is known, then it becomes possible for the base station to send messages addressed to each of the plurality of terminal devices or to send transmission data on behalf of the plurality of terminal devices.

Meanwhile, regarding a case when the terminal device requests for an alternative connection with a different base station, the relay device can reject the request to avoid any inconsistency. As the results, only a single base station is set as the destination for the relay device 100 Moreover, the handover can be done in advance so as to be consistent with the same base station.

More particularly, if connection requests with respect to a base station are received from a plurality of terminal devices by using the first communication method, the relay device 100 establishes a wireless connection with that base station by using the second communication method. Once a wireless connection is established with the base station, the relay device 100 relays the data to be multiplexed between the plurality of terminal devices and the base station by using the first communication method as well as the second communication method.

For example, as illustrated in FIG. 9, when connection requests with respect to a base station are received from a plurality of terminal devices by using the Ethernet/Wi-Fi connection, the relay device 100 switches the connection scheme between the plurality of terminal devices and the base station to the WiMAX connection established via the relay device 100.

Once the relayed connection is established between the plurality of terminal devices and the base station, the relay device 100 relays the data to be communicated between the plurality of terminal devices and the base station by using the Ethernet/Wi-Fi connection between the relay device 100 and the plurality of terminal devices, and by using the WiMAX connection between the relay device 100 and the base station.

### Effect of First Embodiment

As described above, regarding the connection scheme between a terminal device and a base station, when the communication environment for the terminal device is unfavorable and when the connection scheme is to be switched to a relayed connection established via a relay device, the communication system is able to switch the connection scheme between the terminal device and the base station to the relayed connection without having to change the communication methods. As a result, it becomes possible switch the connection scheme in a swift (seamless) manner.

For example, when located outdoors, the terminal device communicates directly with the base station by using the WiMAX connection. If the user moves the terminal device to an indoor location; then, with the aim of switching from the direct communication with the base station to a relayed communication established with the base station via the relay device, the terminal device sends a connection request to the relay device. Once a connection request with respect to the base station is received from the terminal device by using the Ethernet/Wi-Fi connection, the relay device switches the connection established between the terminal device and the base station to the WiMAX connection that is established via the relay device. Once the relayed communication is established between the terminal device and the base station, the relay device relays the data to be communicated between the terminal device and the base station by using the Ethernet/Wi-Fi connection between the relay device and the terminal device and by using the WiMAX connection between the relay device and the base station. As a result, the communication system that includes the relay device and the terminal device in a mutually-connectable manner can switch between different types of connection schemes in a swift (seamless) manner.

### [b] Second Embodiment

Apart from the abovementioned embodiment of the present invention, the present invention can also be implemented by using various other embodiments. Herein, other embodiments are explained by dividing the description into (1) encryption, (2) adjustment of switchover timing, (3) system configuration, (4) relay program, and (5) relayed connection switchover program.

(1) Encryption

In the first embodiment described above, the explanation is given for the case in which the messages between the relay device 100 and the terminal device 200 are communicated without modification. However, the present invention is not limited to that case and it is also possible to communicate the messages between the relay device 100 and the terminal device 200 by using encrypted sessions.

For example, in the case of communicating the messages in an encrypted form between the relay device 100 and the terminal device 200; since the encrypting and decrypting generally increases the processing load, those operations are limited to the high-priority information such as the subscriber information, the authentication messages, and the user sessions in a WiMAX section.

Meanwhile, as the encrypting method, it is possible to follow a unique sequence while making use of known algorithms such as the DES (which stands for Data Encryption Standard) or the AES (which stands for Advance Encryption Standard). Moreover, the relay device 100 can be configured to communicate with the terminal device 200 by making use of techniques such as the IPsec (which stands for Security Architecture for Internet Protocol) or the SSL (which stands for Secure Socket Layer) sitting higher than the network layer.

(2) Adjustment of Switchover Timing

In the first embodiment described above, the explanation is given for the case in which the switchover timing for switching between connection schemes is determined to be the communication timing set in a predetermined frame number. However, the present invention is not limited to that case and, while establishing a wireless connection with a base station by using the second communication method, it is also possible to establish the wireless connection at the timing of sending a ranging signal.

For example, when a connection request with respect to a base station is received from the terminal device 200, the relay device 100 adjusts the timing of starting the transmission to the timing of sending a periodic ranging signal that is sent periodically. Alternatively, the relay device 100 can also be configured to adjust the timing of starting the transmission to the timing of sending a BW ranging signal.

Thus, in the WiMAX technology, since a ranging signal is sent by using a modulation scheme having a large reception margin, the timing of transmitting the ranging signal can be put to use. Besides, since that timing is also the timing at which the base station sends a correction instruction regarding the appropriate electrical power, the timing of transmitting the ranging signal can be put to use.

(3) System Configuration

The processing procedures, the control procedures, specific names, various data, and information containing a variety of data and parameters (e.g., information held in the context storage unit 111 illustrated in FIG. 2) described in the embodiments or illustrated in the drawings can be changed as required unless otherwise specified.

The constituent elements of the device illustrated in the drawings are merely conceptual, and need not be physically configured as illustrated. The constituent elements, as a whole or in part, can be separated or integrated either functionally or physically based on various types of loads or use conditions. For example, the connection control unit 121 can be separated into an “authentication processing unit” for processing control messages related to authentication and a “connection control unit” for performing processing related to connection. Moreover, the process functions performed by the device are entirely or partially realized by the CPU or computer programs that are analyzed and executed by the CPU, or realized as hardware by wired logic.

(4) Relay Program

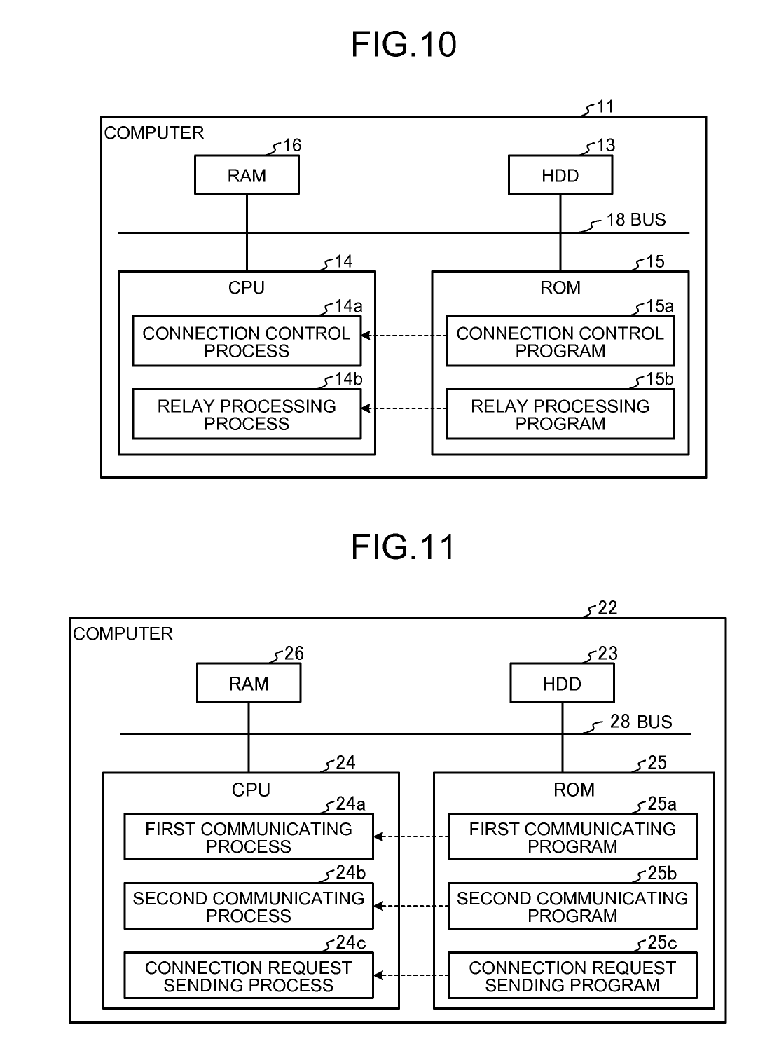

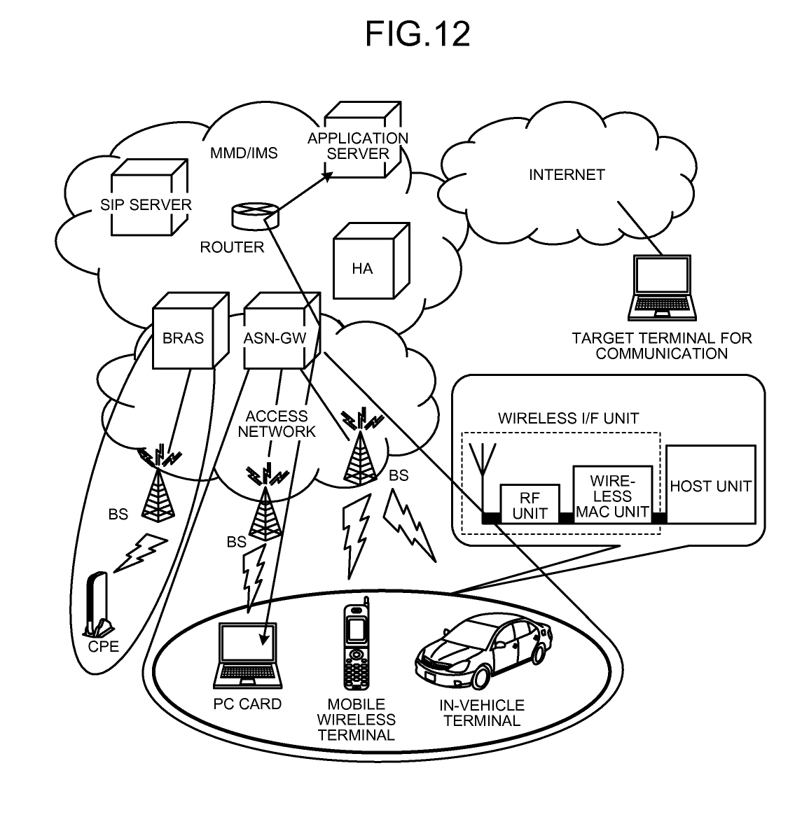

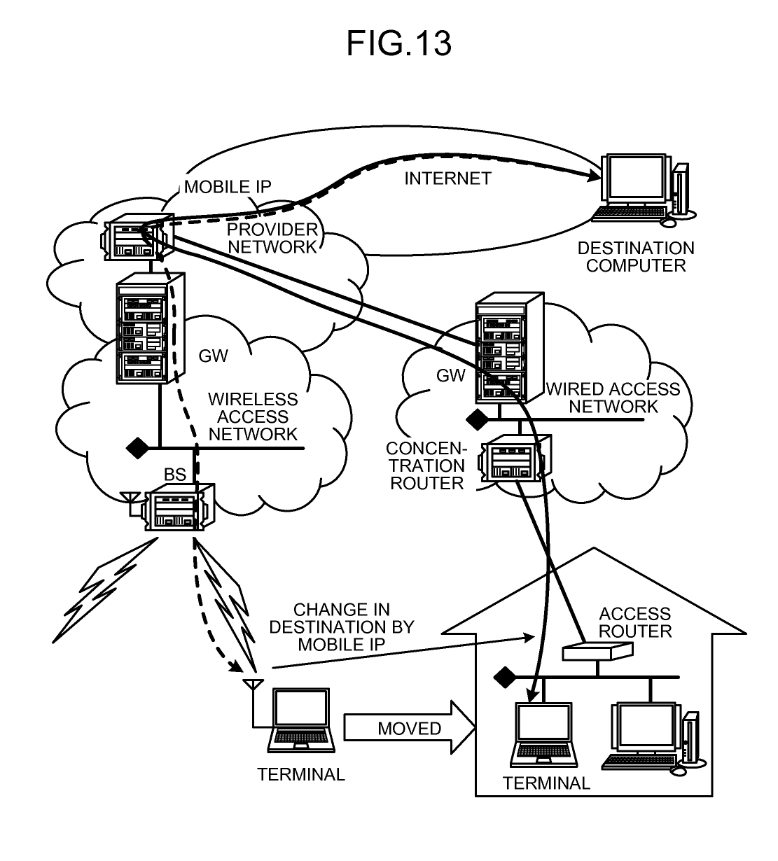

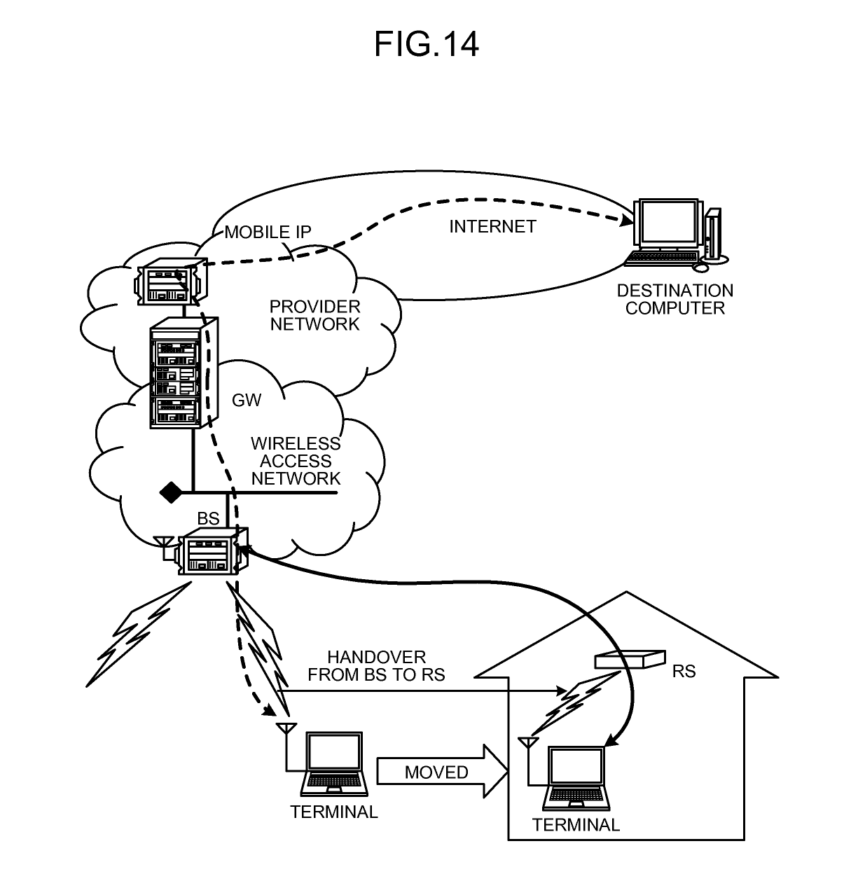

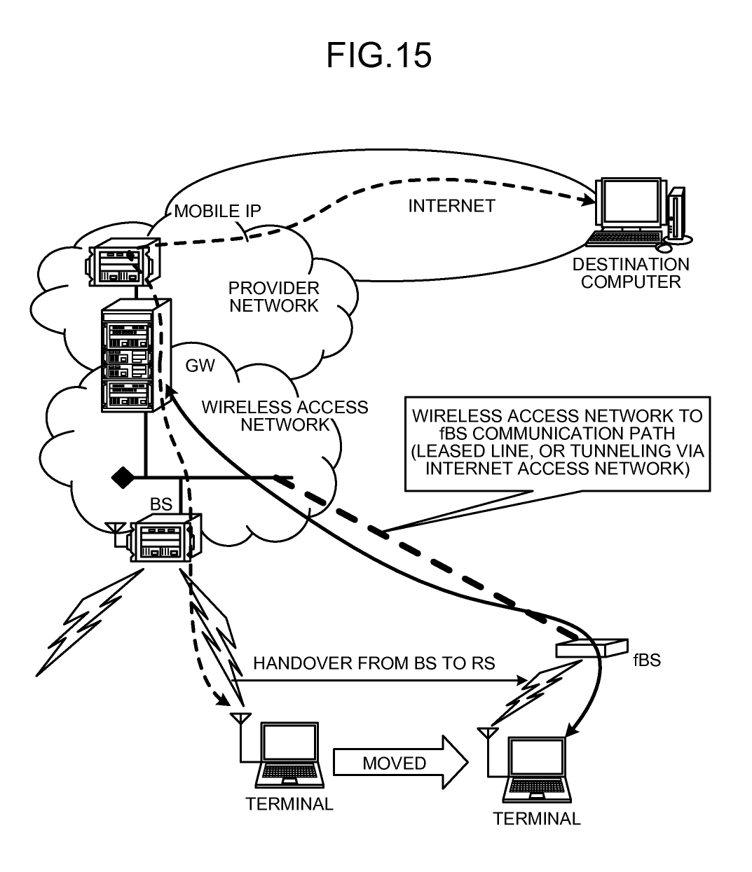

Meanwhile, in the above embodiment, the explanation is given for the case when various operations are implemented with the use of hardware logic. However, the present invention is not limited to that case and can be implemented by executing a program that is written in advance in a computer. Explained below with reference to FIG. 10 is an exemplary block diagram of a computer that executes a relay program having identical functions to those of the relay device 100 according to the first embodiment. FIG. 10 is a block diagram of a computer that executes a relay program.

As illustrated in FIG. 10, a computer 11 functioning as a relay device includes an HDD 13, a CPU 14, a ROM 15, and a RAM 16 that are interconnected by a bus 18.

In the ROM 15 or the RAM 16 are stored in advance relay programs performing identical functions to those of the relay device 100 according to the first embodiment. More particularly, as illustrated in FIG. 10, in the ROM 15 or the RAM 16 are stored in advance a connection control program 15a and a relay processing program 15b. These programs 15a and 15b can be appropriately integrated or separated in an identical manner to the constituent elements of the relay device 100 illustrated in FIG. 2.

The CPU 14 reads the programs 15a and 15b from the ROM 15 or the RAM 16 and executes them so that, as illustrated in FIG. 10, the programs 15a and 15b respectively function as a connection control process 14a and a relay processing process 14b. Herein, the processes 14a and 14b correspond to the internal communication I/F unit 101, the mobile communication I/F unit 102, the connection control unit 121, and the data relay processing unit 122 illustrated in FIG. 2.

The CPU 14 executes the relay program based on the data stored in the RAM 16 or the HDD 13.

Meanwhile, the programs 15a and 15b need not be stored in the ROM 15 from the start. Alternatively, for example, it is possible to store those programs in a portable physical medium such as a flexible disk (FD), a CD-ROM, a DVD, a magnetic optical disk, or an IC card that is inserted in the computer 11; in a fixed physical medium such as an HDD installed inside or outside of the computer 11; or in another computer (or server) that is connected to the computer 11 via a public line, the Internet, a LAN, or a WAN. The computer 11 can then read those stored programs and execute the same.

(5) Relayed Connection Switchover Program

In the first embodiment, the explanation is given for the case when various operations are implemented with the use of hardware logic. However, the present invention is not limited to that case and can be implemented by executing a program that is written in advance in a computer. Explained below with reference to FIG. 11 is an exemplary block diagram of a computer that executes a relayed connection switchover program having identical functions to those of the terminal device 200 according to the first embodiment. FIG. 11 is a block diagram of a computer that executes a relayed connection switchover program.

As illustrated in FIG. 11, a computer 22 functioning as a relay device includes an HDD 23, a CPU 24, a ROM 25, and a RAM 26 that are interconnected by a bus 28.

In the ROM 25 or the RAM 26 are stored in advance relay programs performing identical functions to those of the terminal device 200 according to the first embodiment. More particularly, as illustrated in FIG. 11, in the ROM 25 or the RAM 26 are stored in advance a first communicating program 25a, a second communicating program 25b, and a connection request sending program 25c. These programs 25a to 25c can be appropriately integrated or separated in an identical manner to the constituent elements of the terminal device 200 illustrated in FIG. 3.

The CPU 14 reads the programs 25a to 25c from the ROM 25 or the RAM 26 and executes them so that, as illustrated in FIG. 11, the programs 25a to 25c respectively function as a first communicating process 24a, a second communicating process 24b, and a connection request sending process 24c. Herein, the processes 24a to 24c respectively correspond to the internal communication I/F unit 201, the mobile communication I/F unit 202, and the connection management unit 221 illustrated in FIG. 3.

The CPU 24 executes the relayed connection switchover program based on the data stored in the RAM 26 or the HDD 23.

Meanwhile, the programs 25a to 25c need not be stored in the ROM 25 from the start. Alternatively, for example, it is possible to store those programs in a portable physical medium such as a flexible disk (FD), a CD-ROM, a DVD, a magnetic optical disk, or an IC card that is inserted in the computer 22; in a fixed physical medium such as an HDD installed inside or outside of the computer 22; or in another computer (or server) that is connected to the computer 22 via a public line, the Internet, a LAN, or a WAN. The computer 22 can then read those stored programs and execute the same.

According to an aspect of the present invention, it becomes possible to switch between different types of connection schemes in a seamless manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A relay device comprising:
a mobile communication interface unit configured to communicate with base stations;
an internal communication interface unit configured to communicate with terminal devices; and
a processor,
wherein the processor is configured to
establish a wireless connection with a base station by using a second communication method in response to a connection request, the connection request being received by using a first communication method from a terminal device having wireless communication capability and being issued with respect to the base station; and
relay, upon establishment of a wireless connection with the base station, data to be communicated between the terminal device and the base station by using the first communication method and the second communication method.

2. The relay device according to claim 1, wherein
the connection request includes transmission power control information between the terminal device and a last base station with which the terminal device had established a wireless connection before sending the connection request, and
at the time of establishing a connection with the base station by using the second communication method, the processor determines a transmission power based on the transmission power control information and based on an electrical power received from the base station.

3. The relay device according to claim 1, wherein, at the time of establishing a connection with the base station by using the second communication method, the processor relays to the terminal device control messages for wireless connection authentication received from the base station, relays to the base station control messages regarding wireless connection authentication received from the terminal device, and directly controls messages other than the control messages.

4. The relay device according to claim 1, wherein
transmission power control information with respect to a base station, with which the processor establishes a wireless connection, is stored in a memory unit, and
at the time of establishing a connection with the base station by using the second communication method, the processor sets the transmission power control information stored in the memory unit as an initial value of the transmission power.

5. The relay device according to claim 1, wherein
the connection request includes context information containing either an identifier of the terminal device, or the central frequency of the base station, or an identifier of the base station, or a connection identifier of connection with the base station, or an authentication key, or a cryptography key, and
at the time of establishing a connection with the base station by using the second communication method, the processor stores the context information in a memory unit.

6. The relay device according to claim 1, wherein communication with the terminal device is performed by using encryption.

7. The relay device according to claim 1, wherein, at the time of establishing a connection with the base station by using the second communication method, the processor establishes the wireless connection at the timing of sending a ranging signal.

8. The relay device according to claim 1, wherein, upon receiving from the terminal device a connection switchback request for a wireless connection with the base station, the processor terminates the wireless connection that has been established with the base station by using the second communicating method.

9. The relay device according to claim 1, wherein, when communication with the terminal device is terminated, the processor terminates the wireless connection that has been established with the base station by using the second communicating method.

10. The relay device according to claim 1, wherein, when a connection request for an initial connection with the base station is received from the terminal device by using the first communication method, the processor establishes a wireless communication with the base station by using the second communication method.

11. The relay device according to claim 1, wherein
when connection requests with respect to a base station are received from a plurality of terminal devices by using the first communication method, the processor establishes a wireless connection for each of the plurality of terminal devices with the base station by using the second communication method, and
when establishing a wireless connection with the base station, the processor relays data to be multiplexed between the plurality of terminal devices and the base station by using the first communication method as well as the second communication method.

12. A terminal device comprising a processor, wherein
the processor is configured
to establish a connection by using a first communication method between the terminal device and a relay device having wireless communication capability;
to establish a wireless connection by using a second communication method between the terminal device and a base station; and
to send to the relay device a connection request that is issued in a case of switching from a direct wireless connection established between the terminal device and the base station to a connection established between the terminal device and the base station via the relay device.

13. The terminal device according to claim 12, wherein the processor is further configured
to receive, when sending a connection request for switching to a connection established with the base station via the relay device, a control message related to authentication from the relay device; and
to send, when sending a connection request for switching to a wireless connection established with the base station via the relay device, a control message related to authentication to the relay device.

14. The terminal device according to claim 12, wherein the processor is further configured to, after sending a connection request for switching to a wireless connection established with the base station via the relay device, monitor signals received from the base station and, if the receiving sensitivity of the signals is satisfactory, to send to the relay device a connection switchback request for a direct connection with the base station.

15. The terminal device according to claim 12, wherein the processor is further configured to, after sending a connection request for switching to a connection established with the base station via the relay device, and, when communication with the relay device is terminated, switch over to a direct wireless connection with the base station.

16. The terminal device according to claim 12, wherein, without establishing a direct wireless connection with the base station, the processor sends to the relay device a connection request for establishing an initial connection with the base station.

17. A communication system comprising a terminal device; and a relay device, wherein
the terminal device includes a first processor, the first processor being configured to establish a connection by using a first communication method with the relay device;
establish a wireless connection by using a second communication method with a base station; and
send to the relay device a connection request that is issued in a case of switching from a direct wireless connection established with the base station to a connection established with the base station via the relay device, and
the relay device includes
a mobile communication interface unit configured to communicate with base stations;
an internal communication interface unit configured to communicate with terminal devices; and
a second processor, the second processor being configured to
establish a wireless connection with the base station by using the second communication method in response to a connection request that is received by using the first communication method from a terminal device having wireless communication capability and that is issued with respect to the base station; and
relay, upon establishment of a wireless connection with the base station, data to be communicated between the terminal device and the base station by using the first communication method and the second communication method.
